(19) United States
(12) Patent Application Publication
(10) Pub. No.: US 2005/0205645 A1
(43) Pub. Date: Sep. 22, 2005

(54) Refined aluminium strip or sheet for electrolytic capacitors

(76) Inventors: Matthieu Boehm, Voiron (FR); Jean-Remi Butruille, Montbonnot Saint Martin (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/524,118

(22) PCT Filed: Sep. 22, 2003
(86) PCT No.: PCT/FR03/02778

§ 371 Date: Mar. 17, 2005

(51) Int. Cl. B32B 15/04

(52) U.S. Cl. 228/101; 428/698; 428/469

(57) ABSTRACT

This invention relates to a thin refined aluminium sheet or strip with purity greater than 99.9%, designed for making anodes of electrolytic capacitors, with an atomic content of between 5 and 25% of aluminium carbide in the 10 nm thick surface layer, and preferably between 10 and 20%.

### FIELD OF THE INVENTION

The invention relates to thin aluminium sheets or strips with a purity of more than 99.9%, that are subjected to an etching surface treatment designed to increase their specific area, and are then used for manufacturing electrolytic capacitor anodes, and particularly high voltage capacitor anodes.

### STATE OF THE ART

Many authors have studied the influence of the surface of refined aluminium on its etchability and have demonstrated the influence of two main parameters:
the surface oxide layer,
the impurities and doping agents segregated on the surface.

Osawa and Fukuoka recently summarised knowledge about the surface oxide layer (Hyomen Gijutsu (2000) 51 (11) 1117-1120). Studies have shown that pitting may be initiated around crystallites present in the oxide layer, and two types were identified: γ-Al₂O₃ and MgAl₂O₄ (spinel). Pitting is initiated in cracks associated with crystallisation of the oxide film.

Several patent applications also mention the importance of crystallisation of the oxide layer, and particularly JP 08222487 and JP 08-222488 (Mitsubishi Aluminium), JP 2000-216063 and JP2000-216064 (Nippon Foil Mfg) in which the quantity of γ-Al₂O₃ is claimed.

Patent application JP 10-189397 (Sumitomo Light Metal Industries) mentions the importance of MgAl₂O₄ (spinel) presented as being a factor favourable for initiation of pitting.

Several patents mention the beneficial effect of severe hydration of the oxide layer, immersion treatment in boiling water in the presence of various additives in order to increase the etchability of sheets, for example JP 08-306592 (Kobe Steel), JP 2000-232038 (Kobe Steel), JP 05-006840 (Nippon Seihaku), JP 07-150279 (Nippon Seihaku), JP 07-297089 (Nippon Seihaku), U.S. Pat. No. 5,417,839 (Showa Aluminum) and JP 06-104147 (Sumitomo Light Metal Industries).

On the subject of impurities and doping agents segregated on the surface, it is known that many impurities present in the metal during casting, added deliberately or originating from the ore used and that segregate at the surface during the different transformation steps, particularly during hot rolling and final heat treatment, have an influence on the etchability of the sheets.

The main impurities known to affect etching are mentioned by Osawa and Fukuoka. Bismuth segregates at the oxide-aluminium interface and can have a harmful effect, in the same way as boron. Magnesium segregates at the surface of the oxide layer. Lead and indium are known to segregate at a depth of up to 50 nm and to have a favourable effect on etching. Fukuoka has described the surface segregation profiles of boron, magnesium, iron and bismuth (Journal of Japan Institute of Light Metals, 51 (7) 2001, pp 370-377).

Several patents claim the depth profile of impurities such as lead, bismuth and indium, and particularly JP 57-194516 (Toyo Aluminium), US5128836 (Sumitomo Light Metal) and patent application EP 1031638 deposited by the applicant.

Patent EP0490574 by Showa Aluminum describes the beneficial effect of surface enrichment in 16 elements, either at the surface of the oxide layer or at the interface between the oxide layer and the metal, or at the surface of the oxide layer and at the interface. The concentration ratio measured at the ionic probe is between 1.2 and 30.

The patent application JP 04-062820 (Showa Aluminum) describes sheets containing from 1 to 50 ppm of carbon and with carbon enrichment in the 0.1 μm thick surface layer equal to 5 to 300 times the in-body concentration. Surface carbon originates from segregation at the surface of the in-body carbon.

The purpose of the invention is to provide refined aluminium sheets and strips with better etchability than sheets and strips according to the prior art, and to further improve performances of electrolytic capacitors made from these sheets and strips.

### PURPOSE OF THE INVENTION

The purpose of the invention is a thin refined aluminium sheet or strip with purity greater than 99.9%, designed for making anodes of electrolytic capacitors, with an atomic content of between 5 and 25% of aluminium carbide in the 10 nm thick surface layer, and preferably between 10 and 20%.

### DESCRIPTION OF THE INVENTION

The invention is based on the discovery, during tests carried out by the applicant, of refined aluminium sheets that have exceptional etchability characteristics, and cause a significant improvement in the capacitance of capacitors made from these sheets. Many characterisations of these sheets have been made to understand the source of this exceptional performance, and have demonstrated that they contain an unusual quantity of aluminium carbide, located at the interface between the metal and the oxide.

Two analytic methods have demonstrated the aluminium carbide formed, namely ESCA (Electron Spectroscopy for Chemical Analysis) also called XPS (X-ray Photoelectron Spectroscopy), and TEM (Transmission Electron Microscopy).

The use of XPS has demonstrated the formation of carbide after annealing (Al₄C₃≈282 eV using the 72.8 eV position as a reference for the metal aluminium peak). The carbide species of metals are observed on carbon C peak 1 s at energies of between 283 and 281 eV as indicated in the XPS database of the NIST (National Institute of Standards and Technology) or in the manual written by C. D. WAGNER, W. M. RIGGS, L. E. DAVIS and J. F. MOULDER, “Handbook of X-ray Photoelectron Spectroscopy”, Perkin-Elmer Corporation, Physical Electronics Division.

More precisely, for aluminium carbides, the article by C. Hinnen, D. Imbert, J. M. Siffre and P. Marcus, “An in situ XPS Study of Sputter-deposited Aluminium Thin Films on Graphite”, Applied Surface Science, 78, (1994), 219-231, mentions a 282.4 eV peak for Al₄C₃. The article by B. Maruyama, F. S. Ohuchi and L. Rabenberg, “Catalytic Carbide Formation at Aluminium-Carbon Interface”, Journal of Materials Science Letters, 9, (1990), pp 864-866 indicates a 281.5 eV peak for Al₄C₃ and a 282.5 eV peak for the oxicarbide.

Angular XPS analyses in the article by P. J. Cumpson, “Angle-resolved XPS and AES Depth-resolution and a General Comparison of Properties of Depth-profile Reconstruction Methods”, Journal of Electron Spectroscopy and Related Phenomena, 73 (1995), pp. 25-52, show that carbides, unlike surface carbon due to contamination of the test piece by the atmosphere, are located under the oxide layer. Carbides have an angular profile similar to that of metal aluminium that, by definition, is located under the oxide layer.

The XPS method is a means of obtaining a quantitative analysis of the material surface. This method is now widely recognised, and the results are expressed in atomic %. The atomic % of carbide is influenced by the importance of the surface layers (contamination carbon, thickness of the oxide layer), and a method has been defined to obtain an independent quantification of these parameters.

Since the carbides and the metal are both located under the oxide layer and therefore influenced by surface layers in exactly the same way, the proposed method is to determine the ratio of the atomic % of aluminium carbide and aluminium in metal form. Therefore, the % of aluminium carbide in the metal aluminium is used and is calculated as follows:

% carbide in Al metal=atomic % of carbide/(atomic % of carbide+atomic % of Al metal)*100. The percentages of metal aluminium and carbide are determined by XPS measurements; the analysis angle is 45° between the analyser and the surface, and the source is the AlKa mono-chromatised line (1486.8 eV).

The crystallography (Al₄C₃) of TEM examinations made after selective dissolution of aluminium confirms the presence of carbide under the oxide layer.

The TEM examinations indisputably demonstrate the presence of aluminium carbide for sheets and strips according to the invention, although quantification is difficult. The favourable effect of aluminium carbide has been observed for atomic concentrations in aluminium of between 5 and 25%, and its origin was searched for.

Since carbon is only very slightly soluble in solid aluminium (less than 0.1 ppm) and since the carbide formed is very stable, this means that the carbon contained in the aluminium mass is blocked in the form of carbide, and cannot migrate to the surface as is suggested in the following publications:
L. Svendsen and A. Jarfors “Al—Ti—C Phase Diagram”, Materials Science and Technology, 1993 Vol. 9,
R. C. Dorward: Discussion of “Comments on the Solubility of Carbon in Molten Aluminium”, Metallurgical Transactions A, 1990, Vol. 21A,
C. Qiu and R. Metselaar “Solubility of Carbon in liquid Al and Stability of Al₄C₃”, Journal of Alloys and Compounds, 1994, 216, 55-60.

Therefore, it is impossible that carbides present on the surface originate from segregation of internal carbon. On the contrary, this carbon came from the outside and reacted with aluminium on the surface at high temperature.

Sheets and strips according to the invention are manufactured in a known way until the final annealing step. Manufacturing includes production of refined aluminium with a purity of not less than 99.9%. The refining process used may be either so-called “3-layer” electrolytic refining as described in patents FR 759588 and FR 832528, or a segregation process like that described in patent FR1594154. The metal is cast in the form of plates and is homogenised, then hot rolled and then cold rolled to the final thickness of the order of 0.1 mm. The manufacturing procedure usually comprises intermediate annealing between hot rolling and cold rolling, and another annealing between two cold rolling passes. The sheet or strip is then finally annealed under neutral gas, for example argon, at a temperature of between 500 and 580° C.

Sheets and strips according to the invention are obtained by introducing into the neutral gas a gas containing carbon atoms, that can form aluminium carbide at the final annealing temperature. For example we could use methane CH₄ or other gaseous derivatives of carbon such as propane, butane, isobutane, ethylene, acetylene, propene, propyne, butadiene, etc.

The presence of oxide crystallites is well known as being favourable to etching, and inventors suggest that incorporation of carbide under the oxide layer has a similar effect, and increases the density of crystallites on the surface and therefore the tunnel density, thus improving the capacitance of the capacitor.

### EXAMPLE

Twelve test pieces of refined aluminium sheet with 99.99% purity were prepared using the following transformation procedure:
casting of a plate and homogenisation of this plate for 30 h at 600° C.,
hot and cold rolling to a thickness of 0.125 mm,
intermediate annealing for 30 h at 200° C.,
cold rolling to a thickness of 0.1 mm,
final annealing under argon under the conditions described in Table 1, adding 5 or 10% of methane into the argon for the test pieces according to the invention.

We then measured the capacitance of the capacitors made from the pitted test pieces according to the following process: the aluminium sheets are electrolysed in a solution containing 5% HCl and 15% H₂SO₄ with a DC current density of 200 mA/cm² for 60 s at 85° C. The sheets are then electrolysed in a 5% HCl solution, with a DC current density of 50 mA/cm² for 8 minutes at 80° C. Oxide is formed at a voltage of 450 V in a solution of ammonium borate. The capacitance is measured in uF/cm², and is then converted to a percentage with respect to a reference refined sheet. The results obtained are shown in Table 1.

TABLE 1

| Test | % CH₄ | Annealing | Annealing | % carbide | Capacitance |
|---|---|---|---|---|---|
| piece | in Ar | temperature | duration (h) | on surface | (%) |
| 1 | 5 | 545° C. | 15 | 7 | 97 |
| 2 | 5 | 545° C. | 10 | 3 | 101 |
| 3 | 5 | 570° C. | 15 | 12 | 112 |
| 4 | 5 | 570° C. | 10 | 8 | 105 |
| 5 | 10 | 545° C. | 15 | 15 | 108 |
| 6 | 10 | 545° C. | 10 | 12 | 111 |
| 7 | 10 | 570° C. | 15 | 23 | 107 |
| 8 | 10 | 570° C. | 10 | 18 | 106 |
| 9 | 0 | 520° C. | 20 | 0 | 95 |
| 10 | 0 | 545° C. | 15 | 0 | 98 |
| 11 | 0 | 570° C. | 10 | 0 | 97 |
| 12 | 0 | 595° C. | 5 | 0 | 99 |

An improvement of the capacitance is observed for seven out of test pieces 1 to 8 for which final annealing was done by adding methane to the argon, and especially for four test pieces 5 to 8 for which the addition of methane was greater, the average being 108% instead of 104% for test pieces 1 to 4, and 97% for test pieces 9 to 12 according to the prior art.

1. Thin refined aluminium sheet or strip with purity greater than 99.9%, designed for making anodes of electrolytic capacitors, with an atomic content of between 5 and 25% of aluminium carbide in the 10 nm thick surface layer.

2. Sheet or strip according to claim 1, characterised in that the atomic content of aluminium carbide in the surface layer is between 10 and 20%.

3. Method for manufacturing sheets or strips as claimed in claim 1, comprising casting of a refined aluminium plate, its homogenisation, hot rolling, cold rolling and final annealing under neutral atmosphere, characterised in that a gas containing carbon atoms is mixed with the neutral gas.

4. Method according to claim 3, characterised in that the gas containing carbon atoms is selected from the group consisting of methane, propane, butane, isobutane, ethylene, acetylene, propene, propyne, and butadiene.
